(19) United States
(12) Patent Application Publication
(10) Pub. No.: US 2021/0077996 A1
(43) Pub. Date: Mar. 18, 2021

(54) MICROFLUDIC DEVICES FOR VALIDATING FLUIDIC UNIFORMITY

(71) Applicant: HEWLETT-PACKARD DEVELOPMENT COMPANY, L.P., Spring, TX (US)

(72) Inventors: Eric Martin, Corvallis, OR (US); James Michael Gardner, Corvallis, OR (US)

(73) Assignee: HEWLETT-PACKARD DEVELOPMENT COMPANY, L.P., Spring, TX (US)

(21) Appl. No.: 17/049,419

(22) PCT Filed: Aug. 9, 2018
(86) PCT No.: PCT/US2018/046074

§ 371 Date: Oct. 21, 2020

(51) Int. Cl. B01L 3/00; G01N 27/02

(52) U.S. Cl. CPC B01L 3/5027; G01N 27/02; B01L 2200/147; G01N 2035/00237; B01L 2300/0816; B01L 2300/1827; B01L 2300/0627

(57) ABSTRACT

A microfluidic device for validating fluidic uniformity may include a chamber defined in the microfluidic device. and a plurality of sensors located within the chamber. The plurality of sensors being positioned within the chamber in a symmetrical location about a least one element of the chamber. The microfluidic device may also include control logic to activate the sensors to measure a property of a fluid within the chamber and determine whether the element affects the measurement of the property of the fluid provided by the sensors. The control logic may also, in response to a determination that the element does not affect the measurement of the property of the fluid provided by the sensors, determine if the property measured by all the sensors at their respective symmetrical locations within the chamber are uniform within a range of values. The control logic may also, in response to a determination that the element does affect the measurement of the property of the fluid provided by the sensors, measure the property between symmetric pairs of the sensors.

### BACKGROUND

Microfluidics, as it relates to the sciences, may be defined as the manipulation and study of minute amounts of fluids, and microfluidics devices may be used in a wide range of applications within numerous disciplines such as engineering, physics, chemistry, biochemistry, nanotechnology, and biotechnology along with other practical applications. Microfluidics may involve the manipulation and control of small volumes of fluid within various systems and devices such as lab-on-chip devices, printheads, and other types of microfluidic chip devices.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a microfluidic device, according to an example of the principles described herein.

FIG. 2 is a block diagram of a microfluidic system, according to an example of the principles described herein.

FIG. 3 is a flowchart showing a method of validating fluidic uniformity within a microfluidic device, according to an example of the principles described herein.

FIG. 4 is a flowchart showing a method of validating fluidic uniformity within a microfluidic device, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Microfluidic devices may enable manipulation and control of small volumes of fluid through microfluidic fluidic channels or networks of the microfluidic devices. For example, microfluidic devices may enable manipulation and/or control of volumes of fluid on the order of microliters (i.e., symbolized μl and representing units of 10⁻⁶ liter), nanoliters (i.e., symbolized nl and representing units of 10⁻⁹ liter), or picoliters (i.e., symbolized pi and representing units of 10⁻¹² liter). Thus, microfluidic devises process low volumes of fluids to achieve multiplexing, automation, and high-throughput screening.

Microfluidic devices employ sensors such as, for example, biosensors, bioelectrical sensors, cell-based sensors, temperature sensors, impedance sensors, and other sensors that provide point of care diagnostics for medical diagnostics, food analysis, environmental monitoring, drug screening and other point of care applications. Cell-based sensor apparatus, for example, detect or measure cellular signals from living cells of a sample fluid to identify, for example, a specific species of bacteria, virus and/or disease. In operation, as the fluid flows adjacent, past or across the sensors such as electrodes, the sensors detect or convert signals detected in the fluid to electrical signals that are analyzed to determine or identify a characteristic of the fluid detected by the sensor. For example, the sensors may employ an electrode positioned in a chamber such as a reservoir, a micro-reaction (μ-reaction) chamber, a fluidic channel, a retention chamber, a drain chamber, a nozzle chamber, passageways, other chambers, and combinations thereof. An interaction between the fluid and a surface of the electrode may be monitored by applying a small amplitude alternate-current (AC) electric field or static direct current (DC). By activating the sensors in this manner, a physical or chemical property of the fluid may be detected.

Microfluidic devices, such as lab on chip (LOC) devices, are designed for molecular diagnostics, microfluidic mixing, or polymerase chain reaction (PCR), among other reactions. In such devices, ensuring complete fluidic mixing, uniform fluid properties, or, conversely, a desired gradient of the fluid properties may be useful while allowing the fluid to react and detecting the chemical and physical properties of the fluid. The chemical and physical properties that may be detected include, for example, temperature, fluid composition, particle concentration, viscosity, and other chemical and physical properties of the fluid in the chambers of the microfluidic device.

Using distributed sensors such as, for example, electrical impedance sensors and temperature sensors distributed within in a chamber of a microfluidic device, and arranging the sensors symmetrically about elements, structures or other and architectures of the microfluidic device that may influence sensor measurements such as impedance and temperature, a level of fluid uniformity or non-uniformity may be identified. The elements, structures or other and architectures of the microfluidic device may include, for example, fluid inlets, fluid outlets, walls, corners, ground electrodes, pillars, nozzles, drains, other architectures, and combinations thereof. A process may be executed by control logic of the microfluidic device whereby each sensor in the chambers is measured and a response from the sensors including data defining a detected value may be analyzed and compared with an expected uniform and/or symmetric profile. If a fluid sample is found to not have a level of uniformity, remedial measures may be taken. These remedial measures may include causing an actuator to actuate to provide additional mixing, heating of the fluid, cooling of the fluid, pumping, stirring, titrating the fluid, reacting the fluid with another substance, other physical or chemical processes, and combinations thereof.

Without feedback from the symmetrically arranged sensors, a microfluidic device may operate open-loop without assurance of a sample having the desired uniform or non-uniform quality. To maximize the desired uniform or non-uniform property of the fluid being processed and analyzed, significant extra time may be taken by the microfluidic device to process (e.g., mix, heat, cool, pump, stir, react, other physical or chemical processes, and combinations thereof) so that the desired level of uniformity is assured. Additional time taken for experiments leads to inefficiencies in cost and time in processing the fluid within the microfluidic device. Further, using larger quantities of the fluid and other reactants when processing in order to ensure property uniformity of a small sample size which is taken from the larger quantity results in an inefficient consumption of materials.

Examples described herein provide a microfluidic device. The microfluidic device for validating fluidic uniformity may include a chamber defined in the microfluidic device, and a plurality of sensors located within the chamber. The plurality of sensors is positioned within the chamber in a symmetrical location about a least one element of the chamber. The microfluidic device may also include control logic to activate the sensors to measure a property of a fluid within the chamber. The control logic may determine whether the element affects the measurement of the property of the fluid provided by the sensors based on placement of the sensors relative to elements of the fluidic system. The control logic may also, in response to a determination that the element does not affect the measurement of the property of the fluid provided by the sensors, determine if the property measured by all the sensors at their respective symmetrical locations within the chamber are uniform within a range of values. The control logic may also, in response to a determination that the element does affect the measurement of the property of the fluid provided by the sensors, measure the property between symmetric pairs of the sensors.

The elements include heating elements, inlet channels defined in the microfluidic device, outlet channels defined in the microfluidic device, ground electrodes to provide a return path for electrical currents supplied to the sensors, reference electrodes to maintain the fluid at a voltage potential, walls of the chamber, corners of the chamber, pillars formed within the chamber, or combinations thereof. In one example, the sensors may be impedance sensors to detect the property of the fluid within the chamber. In an example, the sensors are temperature sensors to detect a temperature of the fluid within the chamber. The fluid may include a first fluid and a second fluid, and the sensors are impedance sensors to detect an impedance of the first fluid and second fluid as mixed within the chamber.

Examples described herein provide a system for validating fluidic uniformity within a microfluidic device. The system may include a fluid detection array including a plurality of sensors located within a chamber of the microfluidic device. The plurality of sensors being positioned within the chamber in a symmetrical location about a least one element of the chamber. The system may also include control logic to measure a property of the fluid between a plurality of sensors, determine whether the fluid includes an expected uniformity based on the measured values from the plurality of sensors, and, in response to a determination that the expected uniformity of the fluid is not present within the chamber, activating an actuator to drive the fluid to the expected uniformity within the chamber.

The control logic determines whether the element affects the measurement of the property of the fluid provided by the sensors based on placement of the sensors relative to elements of the fluidic system. In response to a determination that the element does not affect the measurement of the property of the fluid provided by the sensors, the control logic determines if the property measured by all the sensors at their respective symmetrical locations within the chamber are uniform within a range of values. In response to a determination that the element does affect the measurement of the property of the fluid provided by the sensors, the control logic measures the property between symmetric pairs of the sensors.

The elements may include heating elements, inlet channels defined in the microfluidic device, outlet channels defined in the microfluidic device, ground electrodes to provide a return path for electrical currents supplied to the sensors, reference electrodes to maintain the fluid at a voltage potential, walls of the chamber, corners of the chamber, pillars formed within the chamber, or combinations thereof. The sensors include impedance sensors to detect the property of the fluid within the chamber, temperature sensors to detect a temperature of the fluid within the chamber, or combinations thereof.

The fluid includes a first fluid and a second fluid, and the sensors are impedance sensors to detect an impedance of the first fluid and second fluid as mixed within the chamber. The system may include a global thermal sensor to compare a global temperature of the fluid to the measurement of the temperature of the fluid detected by the plurality of sensors.

Examples described herein provide a method of validating fluidic uniformity within a microfluidic device. The method includes measuring a property of a fluid within a chamber of the microfluidic device between a plurality of sensors. The plurality of sensors being positioned within the chamber in a symmetrical location about a least one element of the chamber. The method also includes determining whether the fluid includes an expected uniformity based on the measured values from the plurality of sensors, and in response to a determination that the expected uniformity of the fluid is not present within the chamber, activating an actuator to drive the fluid to the expected uniformity within the chamber.

The method also includes determining whether the element affects the measurement of the property of the fluid provided by the sensors based on placement of the sensors relative to elements of the fluidic system, and in response to a determination that the element does not affect the measurement of the property of the fluid provided by the sensors, determine if the property measured by all the sensors at their respective symmetrical locations within the chamber is uniform within a range of values. The method may also include, in response to a determination that the element does affect the measurement of the property of the fluid provided by the sensors, measuring the property between symmetric pairs of the sensors.

The method may include identifying a region within the chamber at which a uniformity of the fluid is maximized. The method may also include validating an expected property gradient of the fluid within the chamber.

As used in the present specification and in the appended claims, the term “chamber” is meant to be understood broadly as any void within a die of a microfluidic device into which a fluid may be introduced. A chamber may include a reservoir, a micro-reaction (μ-reaction) chamber, a fluidic channel, a retention chamber, a drain chamber, a nozzle chamber, a passageway, other chambers, and combinations thereof.

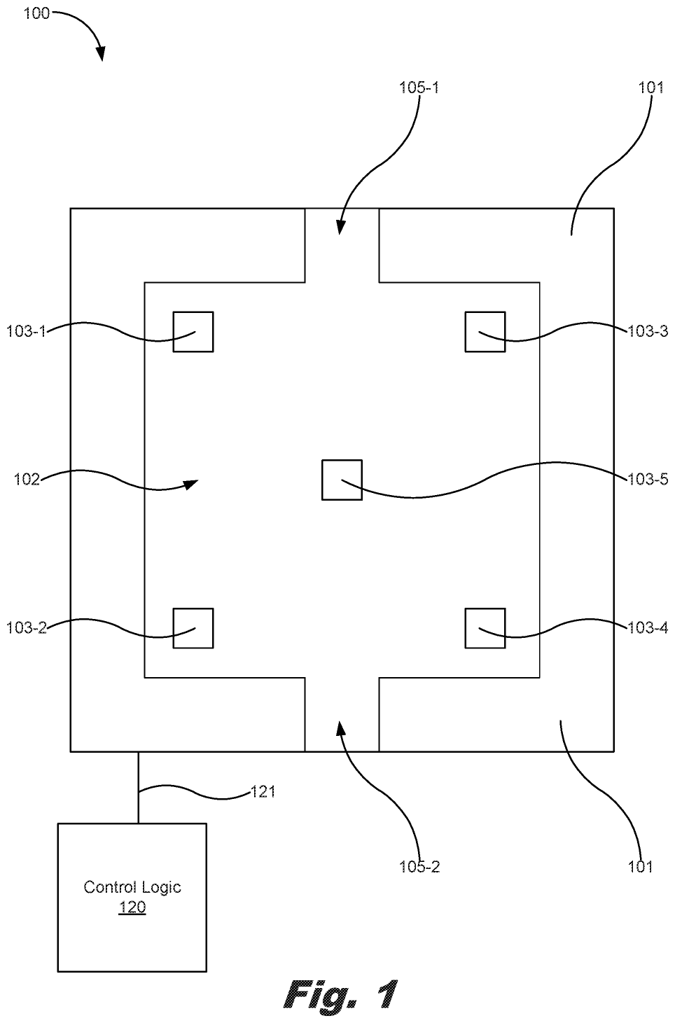

Turning now to the figures, FIG. 1 is a block diagram of a microfluidic device, according to an example of the principles described herein. The elements of the microfluidic devices (100) and their functions and purposes described herein may be used in any type of microfluidic device including, for example, assay systems, point of care systems, and any systems that involve the use, manipulation, control of small volumes of fluid, and combinations thereof. For example, the microfluidic device (100) may incorporate components and functionality of a room-sized laboratory or system to a small chip such as a microfluidic biochip or “lab-on-chip” (LOC) that manipulates and processes solution-based samples and systems by carrying out procedures that may include, for example, mixing, heating, titration, separation, other chemical and physical processes, and combinations thereof. For example, the microfluidic device (100) may be used to integrate assay operations for analyzing enzymes and DNA, detecting biochemical toxins and pathogens, diagnosing diseases, viruses, and bacteria, other chemical and biochemical processes, and combinations thereof.

The microfluidic device (100) may include a die (101) with a microfluidic chamber (102) defined therein. The die (102) may be made of, for example, silicon (Si). In an example, the die (101) may include a plurality of microfluidic chambers (102) defined therein in any configuration and architecture to provide for the movement, mixing, and reacting of fluids within the microfluidic device (100). The microfluidic chambers (102) may include fluidic inlets, reservoirs, chambers, reactors, reaction cites, junctions, channels, capillary breaks, outlets, nozzles, venting ports, drains, and other architectures for use in accomplishing the desired chemical and physical processes of the microfluidic device (100).

The microfluidic device (100) may include control logic (120) communicatively and electrically coupled to a plurality of sensors (103-1, 103-2, 103-3, 103-4, collectively referred to herein as 103) and a number of inlets (105-1, 105-2, collectively referred to herein as 105) to allow a fluid or a plurality of fluids to enter the chamber (102). The control logic (120) of FIG. 1 may be any combination of hardware and computer-readable program code that is executed to force a current into the sensors (103) to sense a physical or chemical property of the fluid. The physical or chemical properties of the fluid may include, for example, the temperature of the fluid, fluid composition, particle concentration, viscosity, and other chemical and physical properties of the fluid in the chambers of the microfluidic device, and combinations thereof. Processing devices within or external to the control logic (120) may be used to analyze the sensed physical and chemical properties of the fluid and provide that data to another computing device for further analysis and storage.

Further, the control logic (120) may monitor for and validate a level of fluidic uniformity or non-uniformity (e.g., a gradient of the property) of a physical or chemical property of the fluid(s) within the chamber (102). The control logic (102) may send signals to the sensors (103) to measure the physical or chemical properties between a plurality of sensors such as, for example, a pair of the sensors (103) where the sensors are positioned within the chamber (102) in a symmetrical location about an architectural element of the chamber such as, for example, fluid inlets, fluid outlets, walls, corners, ground electrodes, pillars, nozzles, drains, other architectures, and combinations thereof. Based on the measured values at the sensors (103), an expected level of uniformity or non-uniformity may be detected and determined. In response to the determination that the expected uniformity of the fluid is not present within the chamber (102), the control logic (120) may activate an actuator to drive the fluid to an expected or desired level of uniformity or non-uniformity within the chamber (102).

Further, the control logic (120) may determine whether the architectural elements within the chamber (102) affect the measurement of the property of the fluid provided by the sensors (103) based on placement of the sensors relative to elements of the fluidic system. Because fluids tend to mix with one another through diffusion, the net movement of molecules or atoms from a region of high concentration or high chemical potential to a region of low concentration or low chemical potential as a result of random motion of the molecules or atoms, in an average and even manner in a chamber (102) that has no architectural elements, the presence of architectural elements within the chamber (102) may affect the manner in which the fluids may mix to homogeneity. For example, if the fluids are introduced into the chamber through two separate inlets (105) that are on opposite ends of the chamber (102) as depicted in FIG. 1, it may be expected that the inlets (105) may affect the manner in which the fluids mix. Further, if, for example, pillars are placed within the chamber (102), the pillars may even further alter the manner in which the fluids are able to mix.

Thus, a pair of sensors (103) that are located symmetrically about the architectural elements of the chamber (102) should yield uniform results in the presence of a fluid that is uniform as to its physical or chemical properties. That expected information may be provided to the control logic (120) of the microfluidic device (100) to determine if that expected uniformity is sensed by the sensors (103). In an example, the chamber (102) may be filled with a fluid that is uniform, and the physical or chemical property of the fluid may be measured at all sensors to determine which sensors produce a uniform signal. With this information from this measurement, new fluids or combinations of fluids or fluidic processing may be introduced into the microfluidic device (100) to allow the microfluidic device (100) to serve as a fluid-analysis tool.

In response to a determination that the architectural elements within the chamber (102) do not affect the measurement of the property of the fluid provided by the sensors (103), the control logic (120) may determine if the property measured by all the sensors (103) at their respective symmetrical locations within the chamber (102) is uniform within a range of values. In response to a determination that the architectural elements do affect the measurement of the property of the fluid provided by the sensors (103), the control logic (120) may cause the sensors (103) to measure the property between symmetric pairs of the sensors (103) that are placed symmetrically about the chamber (102) to determine a level of uniformity or non-uniformity of the mixed fluids.

In response to a determination that the architectural elements within the chamber (102) do affect the measurement of the property of the fluid provided by the sensors (103), the control logic (120) may utilize pairs of the sensors (103) that are located symmetrically about the architectural elements to obtain a measurement about each architectural element. While not all measurements executed by the control logic (120) and detected by the sensors (103) yield identical results, these pairs of sensors (103) that are symmetrically positioned about the architectural elements may detect properties of the fluid about the architectural elements and determine a level of uniformity or non-uniformity of the fluids.

The control logic (120) may also signal the sensors (103) in order to identify a region within the chamber (102) at which a uniformity of the fluid is maximized. Determining a region of maximized uniformity may assist in the microfluidic device (100) and user thereof in refining experimental conditions of the microfluidic device (100) or sample extraction from the microfluidic device (100).

Further, the control logic (120) may validate an expected property gradient of the fluid within the chamber (102). In some instances, it may be desirable to determine how the fluids introduced into the chamber (102) create a gradient of a physical or chemical property during the mixing of the fluids. This may be helpful in determining diffusion rates of the two fluids and expected mixing times of the two fluids. Pairs of the sensors (103) that are located at symmetrical positions about the architectural elements of or within the chamber (102) may be used to detect the gradient of the physical or chemical property of the fluids within the chamber (102). Thus, the microfluidic device (100) is capable of detecting gradients of physical or chemical properties within the chamber (102).

The plurality of sensors (103) are located within a microfluidic chamber (102) of the microfluidic device (100). The sensors (103) may be any type of sensor that detects a chemical or physical property of the fluid or fluids introduced into the chamber (102). In one example, the sensors (103) are impedance sensors that include electrodes that, once in contact with the fluid(s), are used to detect the impedance of the fluid(s). The impedance of a fluid may be indicative of a chemical or physical property of the fluid(s) including the particle concentration within the fluid, the chemical bonds between atoms and molecules of the fluid(s), other chemical or physical properties of the fluid(s), or combinations thereof.

In an example, the impedance sensors (103) may positioned throughout the microfluidic device (100) where they may contact a fluid that is subjected to testing within the microfluidic device (100). The control logic (120) may be used to send electrical signals to the impedance sensors (103), receive detected impedance values at the sensors (103), activate a number of actuators to control a physical or chemical property of the fluids and validate a level of fluidic uniformity of the fluids within the chamber (102) of the microfluidic device (100), perform other processes, and combinations thereof. Throughout the present description, the control logic (120) may be coupled to any device within the microfluidic device (100) including the sensors (103) and activation devices such as mixers, heaters, cooling elements, and other actuators to control the activation of the sensors and actuators and the receipt of data from the sensors. In one example, to measure the impedance at the impedance sensors (103), a small current may be forced into the impedance sensors (103), and a resulting voltage may be measured after a predetermined amount of time.

In the example where a fixed current is applied to the fluid surrounding the impedance sensor (103), a resulting voltage may be sensed. The sensed voltage may be used to determine an impedance of the fluid, whether it be air or another fluid such as an analyte, surrounding the impedance sensor (103) at that area within the microfluidic chamber (102) at which the impedance sensor (103) is located. Electrical impedance is a measure of the opposition that the circuit formed from the impedance sensor (103) and the fluid presents to a current when a voltage is applied to the impedance sensor (103), and may be represented as follows:

$$Z = \frac{V}{I} \qquad Eq . 1$$

where Z is the impedance in ohms (Ω), V is the voltage applied to the impedance sensor (103), and I is the current applied to the fluid surrounding the impedance sensor (103). In another example, the impedance may be complex in nature, such that there may be a capacitive element to the impedance where the fluid may act partially like a capacitor. For complex impedances, the current applied to the impedance sensor (103) may be applied for a particular period of time, and a resulting voltage may be measure at the end of that time.

The detected impedance (Z) is proportional or corresponds to an impedance value of the fluid; whether that fluid is air or another fluid within the microfluidic chamber (102). Stated in another way, the impedance (Z) is proportional or corresponds to, for example, a dispersion level of the particles, ions, or other chemical and physical properties of the fluids. In one example, if the impedance detected at the impedance sensors (103) is relatively lower, this may indicate that the fluid has a lower impedance in that area at which the impedance is detected. This relatively lower impedance may indicate that the fluid surrounding the impedance sensor (103) is air which, in many cases, may have a lower impedance relative to other fluids such as analytes, solvents, and other chemical solutions. Conversely, if the impedance detected at the impedance sensors (103) is relatively higher, this may indicate that the fluid has a higher impedance in that area at which the impedance is detected. This relatively higher impedance within that portion of the fluid may indicate that the fluid surrounding the impedance sensor (103) is a fluid other than air which, in many cases, may have a higher impedance relative to the other fluids such as analytes, solvents, and other chemical solutions. Further, two separate fluids may have differing impedance values. In this manner, fluids within the chamber (102) may be distinguished from one another. Still further, two fluids introduced into the chamber (102) may each have a different impedance value with respect to one another and with respect to a mixture of the two fluids. In this manner, the microfluidic device (100) may use the impedance sensors (103) to distinguish between the two fluids and measure the level at which the two fluids have been mixed.

In another example, the sensors (103) may be temperature sensors. In this example, the temperature sensors may be bulk sensors such as thermal sense resistors or thermal diode sensors that are routed over a large proportional area of the chamber (102) so as to provide an average temperature reading of the fluid within the die (101) or the die (101) itself. In another example, the temperature sensors may be point sensors such as, for example, thermal diodes that are arranged along various locations within the chamber (102) where each point sensor provides a localized temperature measurement of the fluid at that region or point of the chamber (102). The temperatures sensed by the thermal point sensors (103) may be used to determine a uniformity or non-uniformity (e.g., a gradient) of temperature throughout the chamber (102).

As depicted in FIG. 1, the sensors (103) are arranged symmetrically about the chamber (102). For example, a first sensor (103-1) and a third sensor (103-3) may be symmetrically positioned around the first inlet (105-1) on either side of the orifice of the first inlet (105-1). Similarly, a second sensor (103-2) and a fourth sensor (103-4) may be symmetrically positioned around the second inlet (105-2) on either side of the orifice of the second inlet (105-2). A fifth sensor (103-5) may be positioned directly in the middle of the chamber (102), and, in some instances, may serve as a reference sensor when used individually, and, in other instances, may serve as one sensor (103) in a pair of sensors (103) used to determine uniformity or non-uniformity of the fluids within the chamber (102).

Further, the sensors (103) may be arranged symmetrically with respect to one another. For example, the first sensor (103-1) may be symmetrically arranged in a first coordinate direction with respect to the third sensor (103-3) and symmetrically arranged in a second coordinate direction with respect to the second sensor (103-2). In this manner, the symmetrical arrangement of pairs of sensors (103) may be used to detect differences in physical and chemical properties between the two sensors (103) in the pair of sensors.

Because the microfluidic device (100) of FIG. 1 includes inlets (105-1, 105-2) that are located on opposite sides of the chamber (102), the sensors (103) may be arranged and analyzed to detect uniformity or gradients within the chamber (102) as the fluids from the inlets (105) enter the chamber (102). Thus, the control logic (120) may, when detecting a level of uniformity within the chamber (102), expect symmetry of the fluids between the sensor pair made up the first sensor (103-1) and the third sensor (103-3), and between the sensor pair made up the second sensor (103-2) and the fourth sensor (103-4). Further, the control logic (120), when detecting a level of uniformity within the chamber (102), may expect gradients of the fluids between the sensor pair made up the first sensor (103-1) and the second sensor (103-2), and between the sensor pair made up the third sensor (103-3) and the fourth sensor (103-4).

Further, the control logic (120), when detecting a level of uniformity within the chamber (102), may expect the fifth sensor (103-5) to return a sensed value that is an average of the other four sensors (103-1, 103-2, 103-3, 103-4). Still further, the control logic (120), when detecting a level of uniformity within the chamber (102), may expect gradients of the fluids between the sensor pair made up the fifth sensor (103-5) and any one of the other four sensors (103-1, 103-2, 103-3, 103-4) since the average value sensed by the fifth sensor (103-5) may be different from the other four sensors (103-1, 103-2, 103-3, 103-4) in a gradient manner.

In an example where the sensors (103) are thermal diode sensors, the diodes may be arranged in bulk on a substrate within the chamber (102), and may be driven with a reference current, and derivative of the returned voltage over time (Vt) as a function of the temperature may be measured. In examples where the sensors (103) are impedance sensors, the sensed impedances at the sensors (103) may be compared to determine the uniform or gradient levels of the fluids.

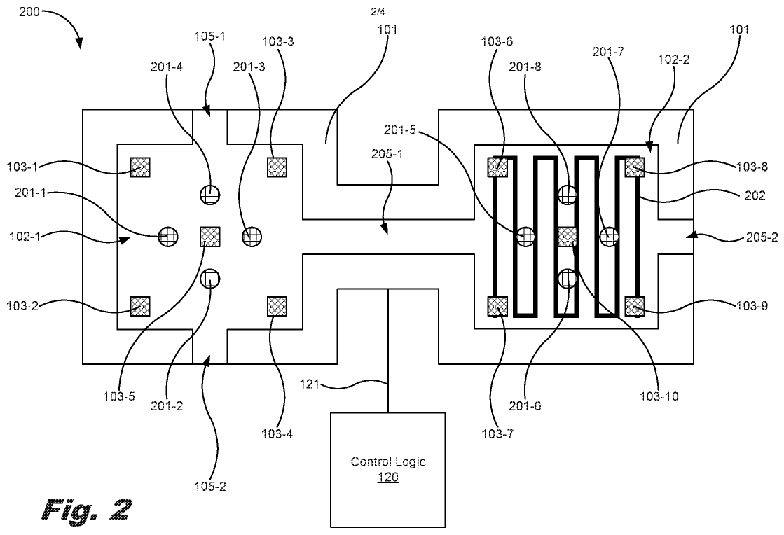

FIG. 2 is a block diagram of a microfluidic system (200), according to an example of the principles described herein. The microfluidic system (200) of FIG. 2 may include a micr0lfuidic device (100) that includes a plurality of chambers (102-1, 102-2) fluidically coupled to one another via a first outlet (205-1) extending from the first chamber (102-1) to a second chamber (102-2). The microfluidic system (200) includes many elements that are included within the microfluidic device (100) of FIG. 1.

The microfluidic system (200) of FIG. 2 may also include a number of actuators (201-1, 201-2, 201-3, 201-4, 201-5, 201-6, 201-7, 201-8, collectively referred to herein as 201), a global sensor (202) located within the second chamber (102-2), and a plurality of additional sensors (103-6, 103-7, 103-8, 103-9, 103-10) within the second chamber (102-2). The actuators (201) may be any device actuatable by the control logic (120) to affect a physical or chemical change in the fluids introduced into the chambers (102-1, 102-2). For example, the actuators (201) may be heating devices to heat the fluids, cooling devices to cool the fluid, pumps to move the fluid within and between the chambers (102-1, 102-2), stirring devices to mix the fluids, other devices, and combinations thereof. The actuators (201) may be placed within the chambers (102-1, 102-2) in a symmetrical layout so as to allow the fluids to be symmetrically acted upon by the actuators (201) and to obtain a uniform effect on the fluids.

The actuators (201) may be controlled by the control logic (120) based on the data received from the sensors (103) sensing the properties of the fluids. For example, if the control logic (120) activates the pair of sensors including the first sensor (103-1) and the second sensor (103-2) which may be impedance sensors, determines that the two impedance values returned from these sensors (103-1, 103-2) indicate that the fluids are not properly mixed, then the control logic (120) may activate a first actuator (201-1) which may be a stirring device to mix the two fluids until a uniform mixture is detected. One example of a stirring device may include a thermal ink jet (TIJ) heater resistor, which, when energized, causes nucleation of the fluid to form a bubble which causes displacement of fluid. In another example, the fluid introduced through the inlet (105-2) may be detected by the second sensor (103-2), which may be a temperature sensor, as being a different temperature as the fluid surrounding the fourth sensor (103-4), also a temperature sensor located on the opposite side of the inlet (105-2). The control logic (120), in this example, may actuate the second actuator (201-2) and the third actuator (201-3) which may be heating or cooling devices to adjust the temperature so that it is uniform with the temperature sensed at the second sensor (103-2).

Gradients within the fluids may also be maintained within the fluids by the control logic (120) sensing, for example, the temperatures detected between a first pair of sensors including the first sensor (103-1) and the second sensor (103-2) to determine if a gradient exists. In this example, it may be expected to detect a relatively cooler temperature at the first sensor (103-1) and a relatively hotter temperature at the second sensor (103-2), and it may be desirable to maintain that temperature gradient. Thus, the control logic (120) may activate the fourth actuator (201-4) to cool the fluid closest to the first sensor (103-1) and activate a second sensor (103-2) to heat the fluid closest to the second sensor (103-2) to maintain the temperature gradients of the fluids within the chamber (102-1). These same examples apply also to the sensors 103-6, 103-7, 103-8, 103-9, 103-10) and sensors (103-6, 103-7, 103-8, 103-9, 103-10) within the second chamber (102-2).

The global sensor (202) may be any device capable of detecting a physical or chemical property of a fluid within a chamber (201-1, 201-2) of the microfluidic system (200). The global sensor (202) maybe a global temperature sensor, a global impedance sensor, or another type of global sensor. In the example of FIG. 2, the global sensor (202) is placed in the second chamber (102-2) after the two fluids introduced at the two inlets (105-1, 105-2) of the first chamber (102-2) have moved through the first outlet (205-1) and into the second chamber (102-2). This will allow the global sensor (202) to detect an average temperature of the mixed fluid, for example, where the global sensor (202) is a global temperature sensor.

Once the fluid is mixed in the first chamber (102-1) and the mixed fluid flows into the second chamber (102-2) via the first outlet (205-1), the mixed fluid may then be given time to further react and be further analyzed and adjusted by the control logic (120) actuating the sensors (103-6, 103-7, 103-8, 103-9, 103-10) and the actuators (201-5, 201-6, 201-7, 201-8) located in the second chamber (102-2). In this manner, both the first chamber (102-1) and the second chamber (102-2) may function as μ-reaction chambers where the fluids are allowed to react with one another and be further manipulated depending on the type of physical and chemical analysis the fluids are being subjected to. The second chamber (102-2) may also include a second outlet (205-2) to allow the mixed fluid to drain out of the microfluidic system (200).

The microfluidic device (100) and microfluidic system (200) of FIGS. 1 and 2, respectively, may include many additional reservoirs, μ-reaction chambers, fluidic channels, retention chambers, drain chambers, nozzle chambers, passageways, other chambers, and combinations thereof to achieve a desired network of chambers that serve the purposes of the lab-on-chip processes described herein. The microfluidic device (100) and microfluidic system (200) may be more or less intricate then those examples depicted in FIGS. 1 and 2, and may be designed to include may different chambers to allow for the fluids to be subjected to a plurality of different physical and chemical processes and allow, at any point in those processes to detect the physical and chemical properties of the fluids via the sensors (103). Further, in the examples depicted in FIGS. 1 and 2, a number of ground electrodes may be included to provide an electrical return path for the sensors (103). Further, in the examples depicted in FIGS. 1 and 2, each sensor (103) and actuator (201) may be electrically and communicatively coupled to the control logic (120) to allow the control logic (120) to independently and collectively control the activation of the sensors (103) and actuators (201).

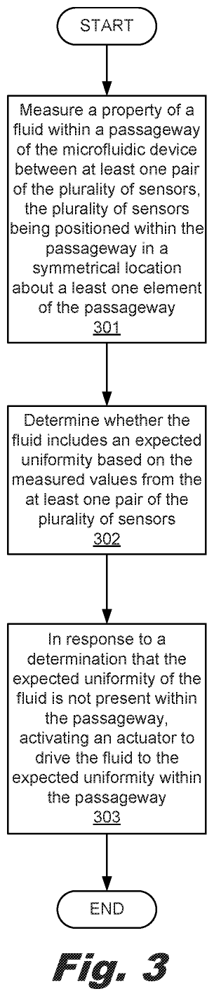

FIG. 3 is a flowchart showing a method (300) of validating fluidic uniformity within a microfluidic device, according to an example of the principles described herein. Validation of fluidic uniformity includes validating that the fluid or fluids within a microfluidic device (100) or microfluidic system (200) is or are existent at a desired or expected uniformity or non-uniformity (e.g., a gradient). The method (300) may begin by measuring (block 301) a property of a fluid within a chamber (102) of the microfluidic device (100) between a plurality of sensors such as, for example, a pair of sensors (103). The plurality of sensors (103) may be positioned within the chamber (102) in a symmetrical location about a least one architectural element of the chamber (102) such as, for example, fluid inlets, fluid outlets, walls, corners, ground electrodes, pillars, nozzles, drains, other architectures, and combinations thereof.

The method may also include determining (block 302) whether the fluid includes an expected uniformity based on the measured values from the plurality of sensors (103) such as, for example, pairs of sensors (103). The pairs of sensors (103) may include any two sensors (103) located within the chamber, and, in one example, may include any two sensors (103) that are arranged symmetrically within the chamber (102) with respect to one another. In response to a determination that the expected uniformity of the fluid is not present within the chamber (102), the method (300) may include activating (block 303) an actuator (201) to drive the fluid to the expected uniformity within the chamber (102). Thus, due to the symmetrical arrangement of sensors (103) within the chamber (102) and their symmetric arrangement with respect to one another, the uniformity or non-uniformity of the fluid may be detected and either maintained or adjusted depending on the desired outcome of the physical and/or chemical processes the fluid is being subjected to.

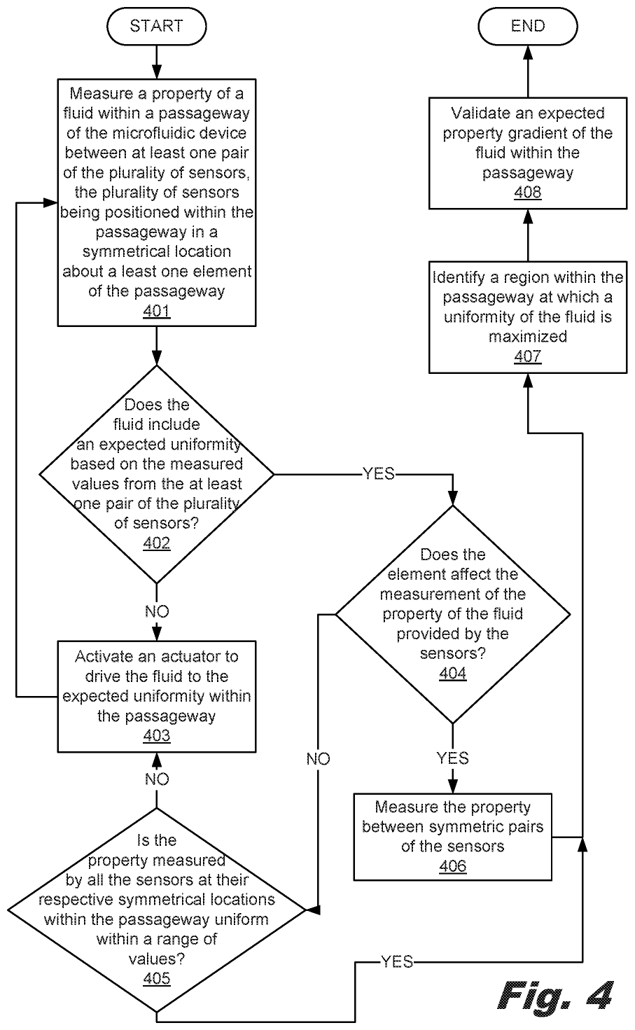

FIG. 4 is a flowchart showing a method (400) of validating fluidic uniformity within a microfluidic device, according to an example of the principles described herein. The method (400) may begin by measuring (block 401) a property of a fluid within a chamber (102) of the microfluidic device (100) between a plurality of the sensors (103). The control logic (120) sends a signal to the sensor (103) to instruct the sensor (103) to detect the desired property. The plurality of sensors (103) may be positioned within the chamber (102) in a symmetrical location about a least one architectural element of the chamber (102) such as, for example, fluid inlets, fluid outlets, walls, corners, ground electrodes, pillars, nozzles, drains, other architectures, and combinations thereof.

At block 402, it may be determined whether the fluid or fluids include an expected uniformity based on the measured values from the plurality of sensors (103). In response to a determination that the fluid or fluids do not include an expected uniformity (block 402, determination NO), then the control logic (120) may activate (block 403) an actuator to drive the fluid to the expected uniformity within the chamber. The method may then loop back to block 401 to perform another measurement, and this loop may be performed any number of times until the desired level of uniformity is achieved.

In response to a determination that the fluid or fluids do include an expected uniformity (block 402, determination NO), then a determination may be made at block 404 as to whether an element within the chamber (102), affects the measurement of the property of the fluid provided by the sensors (103). In response to a determination that an element within the chamber (102), affects the measurement of the property of the fluid provided by the sensors (103) (block 404, determination YES), then the control logic (120) may measure (406) the property between symmetric pairs of the sensors (406). By measuring the property using symmetric pairs of sensors (103), the differences between that property at the locations of those two sensors (103) in that pair may be considered when making adjustments to the fluids using the actuators (201) and in reporting data regarding the fluid to a user.

In response to a determination that an element within the chamber (102), does not affect the measurement of the property of the fluid provided by the sensors (103) (block 404, determination NO), then it may be determined (block 405) whether the property measured by all the sensors at their respective symmetrical locations within the chamber (102) are uniform within a range of values. In one example, the range of values may be a predetermined ranged of impedance or temperature values, for example, that suit the desired level of uniformity of the fluid. In response to a determination that the property measured by all the sensors at their respective symmetrical locations within the chamber (102) are not uniform within a range of values (block 405, determination NO), then the method may loop back to block 403 where the control logic (120) activates (block 403) an actuator to drive the expected uniformity. In response to a determination that the property measured by all the sensors at their respective symmetrical locations within the chamber (102) are uniform within a range of values (block 405, determination YES), then the method may proceed with other processes.

The method may also include identifying (block 407) a region within the chamber (102) at which a uniformity of the fluid is maximized. Identifying a region within the chamber (102) at which a uniformity of the fluid is maximized may be useful in refining experimental conditions and sample extraction by providing a subset of the fluid that is closest to the desired level of uniformity.

The method may also include validating (block 408) an expected property gradient of the fluid within the chamber (102). The control logic (120) may use the data received from the sensors (103) to confirm that a desired gradient of a property of the fluid or fluids within the within the chamber (102) has been meet. This is performed by considering values sensed between pairs of sensors (103) as described herein.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the control logic (120) of the microfluidic device (100) and the microfluidic system (200), or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a microfluidic device. The microfluidic device for validating fluidic uniformity may include a chamber defined in the microfluidic device. and a plurality of sensors located within the chamber. The plurality of sensors being positioned within the chamber in a symmetrical location about a least one element of the chamber. The microfluidic device may also include control logic to activate the sensors to measure a property of a fluid within the chamber and determine whether the element affects the measurement of the property of the fluid provided by the sensors. The control logic may also, in response to a determination that the element does not affect the measurement of the property of the fluid provided by the sensors, determine if the property measured by all the sensors at their respective symmetrical locations within the chamber are uniform within a range of values. The control logic may also, in response to a determination that the element does affect the measurement of the property of the fluid provided by the sensors, measuring the property between symmetric pairs of the sensors.

The devices, systems, and methods described herein provides for faster assurance of an expected property uniformity and/or gradients and shortens experiment time. Further, the devices, systems, and methods described herein provides for assurance of expected property uniformity and/or gradients using smaller sample sizes.

The preceding description has been presented to illustrate and describe examples of the principles described. This description is closed. Many modifications and variations are possible in light of the above teaching.

What is claimed is:

1. A microfluidic device for validating fluidic uniformity, comprising:
a chamber defined in the microfluidic device;
a plurality of sensors located within the chamber, the plurality of sensors being positioned within the chamber in a symmetrical location about an element of the chamber; and
control logic to:
activate the sensors to measure a property of a fluid within the chamber;
determine whether the element affects the measurement of the property of the fluid provided by the sensors based on placement of the sensors relative to the element;
in response to a determination that the element does not affect the measurement of the property of the fluid provided by the sensors, determine if the property measured by all the sensors at their respective symmetrical locations within the chamber are uniform within a range of values; and
in response to a determination that the element does affect the measurement of the property of the fluid provided by the sensors, measure the property between symmetric pairs of the sensors.

2. The microfluidic device of claim 1, wherein the elements comprise heating elements, inlet channels defined in the microfluidic device, outlet channels defined in the microfluidic device, ground electrodes to provide a return path for electrical currents supplied to the sensors, reference electrodes to maintain the fluid at a voltage potential, walls of the chamber, corners of the chamber, pillars formed within the chamber, or combinations thereof.

3. The microfluidic device of claim 1, wherein the sensors are impedance sensors to detect the property of the fluid within the chamber.

4. The microfluidic device of claim 1, wherein the sensors are temperature sensors to detect a temperature of the fluid within the chamber.

5. The microfluidic device of claim 1, wherein:
the fluid comprises a first fluid and a second fluid, and
the sensors are impedance sensors to detect an impedance of the first fluid and second fluid as mixed within the chamber.

6. A system for validating fluidic uniformity within a microfluidic device, comprising:
a fluid detection array comprising a plurality of sensors located within a chamber of the microfluidic device, the plurality of sensors being positioned within the chamber in a symmetrical location about an element of the chamber; and
control logic to:
measure a property of the fluid between a plurality of sensors;
determine whether the fluid comprises an expected uniformity based on the measured values from the plurality of sensors and based on placement of the sensors relative to elements of the fluidic system; and
in response to a determination that the expected uniformity of the fluid is not present within the chamber, activate an actuator to drive the fluid to the expected uniformity within the chamber.

7. The system of claim 6, further comprising, with the control logic:
determine whether the element affects the measurement of the property of the fluid provided by the sensors;
in response to a determination that the element does not affect the measurement of the property of the fluid provided by the sensors, determine if the property measured by all the sensors at their respective symmetrical locations within the chamber are uniform within a range of values; and
in response to a determination that the element does affect the measurement of the property of the fluid provided by the sensors, measure the property between symmetric pairs of the sensors.

8. The system of claim 6, wherein the elements comprise heating elements, inlet channels defined in the microfluidic device, outlet channels defined in the microfluidic device, ground electrodes to provide a return path for electrical currents supplied to the sensors, reference electrodes to maintain the fluid at a voltage potential, walls of the chamber, corners of the chamber, pillars formed within the chamber, or combinations thereof.

9. The system of claim 6, wherein the sensors comprise impedance sensors to detect the property of the fluid within the chamber, temperature sensors to detect a temperature of the fluid within the chamber, or combinations thereof.

10. The system of claim 6, wherein:
the fluid comprises a first fluid and a second fluid, and
the sensors are impedance sensors to detect an impedance of the first fluid and second fluid as mixed within the chamber.

11. The system of claim 6, further comprising a global thermal sensor to compare a global temperature of the fluid to the measurement of the temperature of the fluid detected by the plurality of sensors.

12. A method of validating fluidic uniformity within a microfluidic device, comprising:
measuring a property of a fluid within a chamber of the microfluidic device between the plurality of sensors, the plurality of sensors being positioned within the chamber in a symmetrical location about a least one element of the chamber;
determining whether the fluid comprises an expected uniformity based on the measured values from the plurality of sensors; and
in response to a determination that the expected uniformity of the fluid is not present within the chamber, activating an actuator to drive the fluid to the expected uniformity within the chamber.

13. The method of claim 12, further comprising:
determining whether the element affects the measurement of the property of the fluid provided by the sensors;
in response to a determination that the element does not affect the measurement of the property of the fluid provided by the sensors, determine if the property measured by all the sensors at their respective symmetrical locations within the chamber is uniform within a range of values; and
in response to a determination that the element does affect the measurement of the property of the fluid provided by the sensors, measuring the property between symmetric pairs of the sensors.

14. The method of claim 12, further comprising identifying a region within the chamber at which a uniformity of the fluid is maximized.

15. The method of claim 12, further comprising validating an expected property gradient of the fluid within the chamber.
